(19) United States
(12) Patent Application Publication
(10) Pub. No.: US 2025/0056254 A1
(43) Pub. Date: Feb. 13, 2025

(54) METHOD FOR MULTI-TRP THROUGH TA ACQUISITION

(71) Applicant: Nokia Technologies Oy, Espoo (FI)

(72) Inventors: Halit Murat GÜRSU, Munich (DE); Ahmad AWADA, Munich (DE); Sanjay GOYAL, Denville, NJ (US); Timo KOSKELA, Oulu (FI)

(21) Appl. No.: 18/796,476

(22) Filed: Aug. 7, 2024

(30) Foreign Application Priority Data
Aug. 10, 2023 (IN) 202341053787

(51) Int. Cl. H04W 24/02; H04W 24/08; H04W 36/00; H04W 36/06; H04W 56/00

(52) U.S. Cl. CPC H04W 24/02; H04W 24/08; H04W 36/0072; H04W 36/06; H04W 56/0045

(57) ABSTRACT

An apparatus including at least one processor; and at least one memory storing instructions that, when executed by the at least one processor, cause the apparatus at least to: receive, from a network node, an indication to monitor a possibility of configuring a user equipment for single transmission reception point operation, or receive, from the network node, an indication to monitor a possibility of configuring the user equipment for multiple transmission reception point operation; determine whether it is possible to configure the user equipment for single transmission reception point operation or multiple transmission reception point operation; and transmit, to the network node, an indication that it is possible to configure the user equipment for single transmission reception point operation or multiple transmission reception point operation.

### TECHNICAL FIELD

The examples and non-limiting example embodiments relate generally to communications and, more particularly, to a method for multi-TRP through TA acquisition.

### BACKGROUND

It is known to synchronize transmission and reception timing of network nodes in a communication network.

### SUMMARY

In accordance with an aspect, an apparatus includes at least one processor; and at least one memory storing instructions that, when executed by the at least one processor, cause the apparatus at least to: receive, from a network node, an indication to monitor a possibility of configuring a user equipment for single transmission reception point operation, or receive, from the network node, an indication to monitor a possibility of configuring the user equipment for multiple transmission reception point operation; determine whether it is possible to configure the user equipment for single transmission reception point operation or multiple transmission reception point operation; and transmit, to the network node, an indication that it is possible to configure the user equipment for single transmission reception point operation or multiple transmission reception point operation.

In accordance with an aspect, an apparatus includes at least one processor; and at least one memory storing instructions that, when executed by the at least one processor, cause the apparatus at least to: transmit, to a network node, an indication to monitor a possibility of configuring a user equipment for single transmission reception point operation, or transmit, to the network node, an indication to monitor a possibility of configuring the user equipment for multiple transmission reception point operation; receive, from the network node, an indication that it is possible to configure the user equipment for single transmission reception point operation or multiple transmission reception point operation; and configure the user equipment for single transmission reception point operation or multiple transmission reception point operation, based on the indication received from the network node.

In accordance with an aspect, an apparatus includes at least one processor; and at least one memory storing instructions that, when executed by the at least one processor, cause the apparatus at least to: provide access to a first candidate cell and a second candidate cell; and perform at least one of: receive an indication that single transmission reception point operation is configured for a user equipment, when the user equipment acquired a timing advance for the first candidate cell and failed to acquire a timing advance for the second candidate cell, or receive an indication that multiple transmission reception point operation is configured for the user equipment without a random access channel on the first candidate cell and with a random access channel on the second candidate cell, when the user equipment acquired the timing advance for the first candidate cell and failed to acquire the timing advance for the second candidate cell; and perform the single transmission reception point operation or the multiple transmission reception point operation with the user equipment.

In accordance with an aspect, an apparatus includes at least one processor; and at least one memory storing instructions that, when executed by the at least one processor, cause the apparatus at least to: receive an indication to acquire a timing advance for a first candidate cell and a timing advance for a second candidate cell; perform single transmission reception point operation with the first candidate cell, in response to acquiring the timing advance for the first candidate cell and failing to acquire the timing advance for the second candidate cell; and perform multiple transmission reception point operation without a random access channel on the first candidate cell and with a random access channel on the second candidate cell, in response to acquiring the timing advance for the first candidate cell and failing to acquire the timing advance for the second candidate cell.

In accordance with an aspect, a method includes receiving, from a network node, an indication to monitor a possibility of configuring a user equipment for single transmission reception point operation, or receive, from the network node, an indication to monitor a possibility of configuring the user equipment for multiple transmission reception point operation; determining whether it is possible to configure the user equipment for single transmission reception point operation or multiple transmission reception point operation; and transmitting, to the network node, an indication that it is possible to configure the user equipment for single transmission reception point operation or multiple transmission reception point operation.

In accordance with an aspect, a method includes transmitting, to a network node, an indication to monitor a possibility of configuring a user equipment for single transmission reception point operation, or transmit, to the network node, an indication to monitor a possibility of configuring the user equipment for multiple transmission reception point operation; receiving, from the network node, an indication that it is possible to configure the user equipment for single transmission reception point operation or multiple transmission reception point operation; and configuring the user equipment for single transmission reception point operation or multiple transmission reception point operation, based on the indication received from the network node.

In accordance with an aspect, a method includes providing access to a first candidate cell and a second candidate cell; and performing at least one of: receiving an indication that single transmission reception point operation is configured for a user equipment, when the user equipment acquired a timing advance for the first candidate cell and failed to acquire a timing advance for the second candidate cell, or receiving an indication that multiple transmission reception point operation is configured for the user equipment without a random access channel on the first candidate cell and with a random access channel on the second candidate cell, when the user equipment acquired the timing advance for the first candidate cell and failed to acquire the timing advance for the second candidate cell; and performing the single transmission reception point operation or the multiple transmission reception point operation with the user equipment.

In accordance with an aspect, a method includes receiving an indication to acquire a timing advance for a first candidate cell and a timing advance for a second candidate cell; performing single transmission reception point operation with the first candidate cell, in response to acquiring the timing advance for the first candidate cell and failing to acquire the timing advance for the second candidate cell; and performing multiple transmission reception point operation without a random access channel on the first candidate cell and with a random access channel on the second candidate cell, in response to acquiring the timing advance for the first candidate cell and failing to acquire the timing advance for the second candidate cell.

In accordance with an aspect, an apparatus includes means for receiving, from a network node, an indication to monitor a possibility of configuring a user equipment for single transmission reception point operation, or receive, from the network node, an indication to monitor a possibility of configuring the user equipment for multiple transmission reception point operation; means for determining whether it is possible to configure the user equipment for single transmission reception point operation or multiple transmission reception point operation; and means for transmitting, to the network node, an indication that it is possible to configure the user equipment for single transmission reception point operation or multiple transmission reception point operation.

In accordance with an aspect, an apparatus includes means for transmitting, to a network node, an indication to monitor a possibility of configuring a user equipment for single transmission reception point operation, or transmit, to the network node, an indication to monitor a possibility of configuring the user equipment for multiple transmission reception point operation; means for receiving, from the network node, an indication that it is possible to configure the user equipment for single transmission reception point operation or multiple transmission reception point operation; and means for configuring the user equipment for single transmission reception point operation or multiple transmission reception point operation, based on the indication received from the network node.

In accordance with an aspect, an apparatus includes means for providing access to a first candidate cell and a second candidate cell; and means for performing at least one of: receiving an indication that single transmission reception point operation is configured for a user equipment, when the user equipment acquired a timing advance for the first candidate cell and failed to acquire a timing advance for the second candidate cell, or receiving an indication that multiple transmission reception point operation is configured for the user equipment without a random access channel on the first candidate cell and with a random access channel on the second candidate cell, when the user equipment acquired the timing advance for the first candidate cell and failed to acquire the timing advance for the second candidate cell; and means for performing the single transmission reception point operation or the multiple transmission reception point operation with the user equipment.

In accordance with an aspect, an apparatus includes means for receiving an indication to acquire a timing advance for a first candidate cell and a timing advance for a second candidate cell; means for performing single transmission reception point operation with the first candidate cell, in response to acquiring the timing advance for the first candidate cell and failing to acquire the timing advance for the second candidate cell; and means for performing multiple transmission reception point operation without a random access channel on the first candidate cell and with a random access channel on the second candidate cell, in response to acquiring the timing advance for the first candidate cell and failing to acquire the timing advance for the second candidate cell.

In accordance with an aspect, a non-transitory program storage device readable by a machine, tangibly embodying a program of instructions executable by the machine for performing operations is provided and described, the operations including receiving, from a network node, an indication to monitor a possibility of configuring a user equipment for single transmission reception point operation, or receive, from the network node, an indication to monitor a possibility of configuring the user equipment for multiple transmission reception point operation; determining whether it is possible to configure the user equipment for single transmission reception point operation or multiple transmission reception point operation; and transmitting, to the network node, an indication that it is possible to configure the user equipment for single transmission reception point operation or multiple transmission reception point operation.

In accordance with an aspect, a non-transitory program storage device readable by a machine, tangibly embodying a program of instructions executable by the machine for performing operations is provided and described, the operations including transmitting, to a network node, an indication to monitor a possibility of configuring a user equipment for single transmission reception point operation, or transmit, to the network node, an indication to monitor a possibility of configuring the user equipment for multiple transmission reception point operation; receiving, from the network node, an indication that it is possible to configure the user equipment for single transmission reception point operation or multiple transmission reception point operation; and configuring the user equipment for single transmission reception point operation or multiple transmission reception point operation, based on the indication received from the network node.

In accordance with an aspect, a non-transitory program storage device readable by a machine, tangibly embodying a program of instructions executable by the machine for performing operations is provided and described, the operations including providing access to a first candidate cell and a second candidate cell; and performing at least one of: receiving an indication that single transmission reception point operation is configured for a user equipment, when the user equipment acquired a timing advance for the first candidate cell and failed to acquire a timing advance for the second candidate cell, or receiving an indication that multiple transmission reception point operation is configured for the user equipment without a random access channel on the first candidate cell and with a random access channel on the second candidate cell, when the user equipment acquired the timing advance for the first candidate cell and failed to acquire the timing advance for the second candidate cell; and performing the single transmission reception point operation or the multiple transmission reception point operation with the user equipment.

In accordance with an aspect, a non-transitory program storage device readable by a machine, tangibly embodying a program of instructions executable by the machine for performing operations is provided and described, the operations including receiving an indication to acquire a timing advance for a first candidate cell and a timing advance for a second candidate cell; performing single transmission reception point operation with the first candidate cell, in response to acquiring the timing advance for the first candidate cell and failing to acquire the timing advance for the second candidate cell; and performing multiple transmission reception point operation without a random access channel on the first candidate cell and with a random access channel on the second candidate cell, in response to acquiring the timing advance for the first candidate cell and failing to acquire the timing advance for the second candidate cell.

### BRIEF DESCRIPTION OF THE DRAWINGS

The foregoing aspects and other features are explained in the following description, taken in connection with the accompanying drawings.

FIG. 1 is a block diagram of one possible and non-limiting system in which the example embodiments may be practiced.

FIG. 2 is an exemplary signaling diagram for L1/2 triggered mobility (LTM).

FIG. 3 is a message sequence chart for triggering sTRP operation or mTRP operation with re-trial on RACH.

FIG. 4 is a message sequence chart for triggering mTRP configuration after UE measurements.

FIG. 5 is a message sequence chart for triggering mTRP configuration after TA acquisition.

FIG. 6 is an example apparatus configured to implement the examples described herein.

FIG. 7 shows a representation of an example of non-volatile memory media used to store instructions that implement the examples described herein.

FIG. 8 is an example method, based on the examples described herein.

FIG. 9 is an example method, based on the examples described herein.

FIG. 10 is an example method, based on the examples described herein

FIG. 11 is an example method, based on the examples described herein.

### DETAILED DESCRIPTION OF EXAMPLE EMBODIMENTS

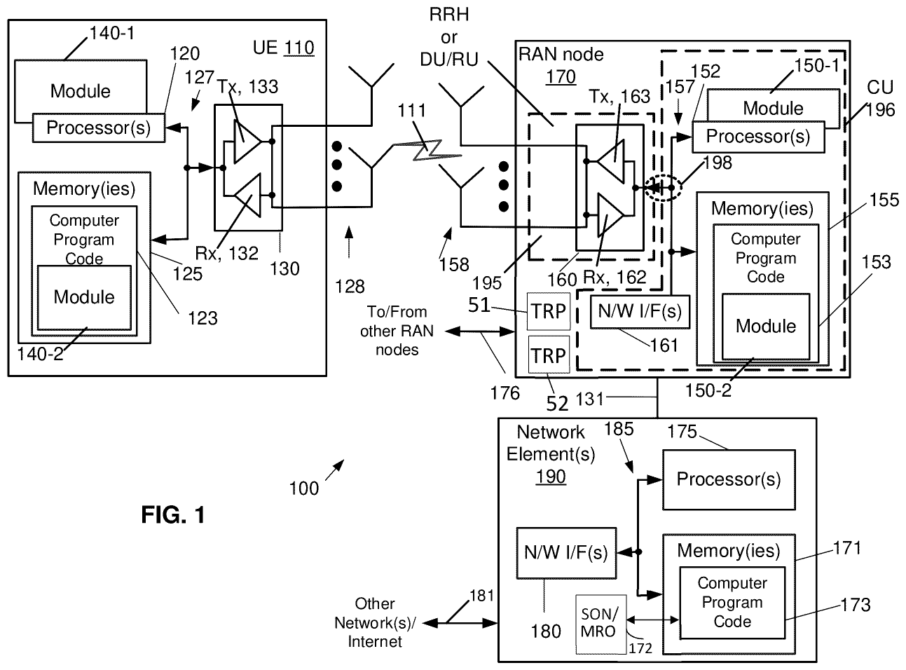

Turning to FIG. 1, this figure shows a block diagram of one possible and non-limiting example in which the examples may be practiced. A user equipment (UE) 110, radio access network (RAN) node 170, and network element(s) 190 are illustrated. In the example of FIG. 1, the user equipment (UE) 110 is in wireless communication with a wireless network 100. A UE is a wireless device that can access the wireless network 100. The UE 110 includes one or more processors 120, one or more memories 125, and one or more transceivers 130 interconnected through one or more buses 127. Each of the one or more transceivers 130 includes a receiver, Rx, 132 and a transmitter, Tx, 133. The one or more buses 127 may be address, data, or control buses, and may include any interconnection mechanism, such as a series of lines on a motherboard or integrated circuit, fiber optics or other optical communication equipment, and the like. The one or more transceivers 130 are connected to one or more antennas 128. The one or more memories 125 include computer program code 123. The UE 110 includes a module 140, comprising one of or both parts 140-1 and/or 140-2, which may be implemented in a number of ways. The module 140 may be implemented in hardware as module 140-1, such as being implemented as part of the one or more processors 120. The module 140-1 may be implemented also as an integrated circuit or through other hardware such as a programmable gate array. In another example, the module 140 may be implemented as module 140-2, which is implemented as computer program code 123 and is executed by the one or more processors 120. For instance, the one or more memories 125 and the computer program code 123 may be configured to, with the one or more processors 120, cause the user equipment 110 to perform one or more of the operations as described herein. The UE 110 communicates with RAN node 170 via a wireless link 111.

The RAN node 170 in this example is a base station that provides access for wireless devices such as the UE 110 to the wireless network 100. The RAN node 170 may be, for example, a base station for 5G, also called New Radio (NR). In 5G, the RAN node 170 may be a NG-RAN node, which is defined as either a gNB or an ng-eNB. A gNB is a node providing NR user plane and control plane protocol terminations towards the UE, and connected via the NG interface (such as connection 131) to a 5GC (such as, for example, the network element(s) 190). The ng-eNB is a node providing E-UTRA user plane and control plane protocol terminations towards the UE, and connected via the NG interface (such as connection 131) to the 5GC. The NG-RAN node may include multiple gNBs, which may also include a central unit (CU) (gNB-CU) 196 and distributed unit(s) (DUs) (gNB-DUs), of which DU 195 is shown. Note that the DU 195 may include or be coupled to and control a radio unit (RU). The gNB-CU 196 is a logical node hosting radio resource control (RRC), SDAP and PDCP protocols of the gNB or RRC and PDCP protocols of the en-gNB that control the operation of one or more gNB-DUs. The gNB-CU 196 terminates the F1 interface connected with the gNB-DU 195. The F1 interface is illustrated as reference 198, although reference 198 also illustrates a link between remote elements of the RAN node 170 and centralized elements of the RAN node 170, such as between the gNB-CU 196 and the gNB-DU 195. The gNB-DU 195 is a logical node hosting RLC, MAC and PHY layers of the gNB or en-gNB, and its operation is partly controlled by gNB-CU 196. One gNB-CU 196 supports one or multiple cells. One cell may be supported with one gNB-DU 195, or one cell may be supported/shared with multiple DUs under RAN sharing. The gNB-DU 195 terminates the F1 interface 198 connected with the gNB-CU 196. Note that the DU 195 is considered to include the transceiver 160, e.g., as part of a RU, but some examples of this may have the transceiver 160 as part of a separate RU, e.g., under control of and connected to the DU 195. The RAN node 170 may also be an eNB (evolved NodeB) base station, for LTE (long term evolution), or any other suitable base station or node.

The RAN node 170 includes one or more processors 152, one or more memories 155, one or more network interfaces (N/W I/F(s)) 161, and one or more transceivers 160 interconnected through one or more buses 157. Each of the one or more transceivers 160 includes a receiver, Rx, 162 and a transmitter, Tx, 163. The one or more transceivers 160 are connected to one or more antennas 158. The one or more memories 155 include computer program code 153. The CU 196 may include the processor(s) 152, one or more memories 155, and network interfaces 161. Note that the DU 195 may also contain its own memory/memories and processor(s), and/or other hardware, but these are not shown.

The RAN node 170 includes a module 150, comprising one of or both parts 150-1 and/or 150-2, which may be implemented in a number of ways. The module 150 may be implemented in hardware as module 150-1, such as being implemented as part of the one or more processors 152. The module 150-1 may be implemented also as an integrated circuit or through other hardware such as a programmable gate array. In another example, the module 150 may be implemented as module 150-2, which is implemented as computer program code 153 and is executed by the one or more processors 152. For instance, the one or more memories 155 and the computer program code 153 are configured to, with the one or more processors 152, cause the RAN node 170 to perform one or more of the operations as described herein. Note that the functionality of the module 150 may be distributed, such as being distributed between the DU 195 and the CU 196, or be implemented solely in the DU 195.

The one or more network interfaces 161 communicate over a network such as via the links 176 and 131. Two or more gNBs 170 may communicate using, e.g., link 176. The link 176 may be wired or wireless or both and may implement, for example, an Xn interface for 5G, an X2 interface for LTE, or other suitable interface for other standards.

The one or more buses 157 may be address, data, or control buses, and may include any interconnection mechanism, such as a series of lines on a motherboard or integrated circuit, fiber optics or other optical communication equipment, wireless channels, and the like. For example, the one or more transceivers 160 may be implemented as a remote radio head (RRH) 195 for LTE or a distributed unit (DU) 195 for gNB implementation for 5G, with the other elements of the RAN node 170 possibly being physically in a different location from the RRH/DU 195, and the one or more buses 157 could be implemented in part as, for example, fiber optic cable or other suitable network connection to connect the other elements (e.g., a central unit (CU), gNB-CU 196) of the RAN node 170 to the RRH/DU 195. Reference 198 also indicates those suitable network link(s).

A RAN node/gNB can comprise one or more TRPs to which the methods described herein may be applied. FIG. 1 shows that the RAN node 170 comprises TRP 51 and TRP 52, in addition to the TRP represented by transceiver 160. Similar to transceiver 160, TRP 51 and TRP 52 may each include a transmitter and a receiver. The RAN node 170 may host or comprise other TRPs not shown in FIG. 1.

A relay node in NR is called an integrated access and backhaul node. A mobile termination part of the IAB node facilitates the backhaul (parent link) connection. In other words, the mobile termination part comprises the functionality which carries UE functionalities. The distributed unit part of the IAB node facilitates the so called access link (child link) connections (i.e. for access link UEs, and backhaul for other IAB nodes, in the case of multi-hop IAB). In other words, the distributed unit part is responsible for certain base station functionalities. The IAB scenario may follow the so called split architecture, where the central unit hosts the higher layer protocols to the UE and terminates the control plane and user plane interfaces to the 5G core network.

It is noted that the description herein indicates that “cells” perform functions, but it should be clear that equipment which forms the cell may perform the functions. The cell makes up part of a base station. That is, there can be multiple cells per base station. For example, there could be three cells for a single carrier frequency and associated bandwidth, each cell covering one-third of a 360 degree area so that the single base station's coverage area covers an approximate oval or circle. Furthermore, each cell can correspond to a single carrier and a base station may use multiple carriers. So if there are three 120 degree cells per carrier and two carriers, then the base station has a total of 6 cells.

The wireless network 100 may include a network element or elements 190 that may include core network functionality, and which provides connectivity via a link or links 181 with a further network, such as a telephone network and/or a data communications network (e.g., the Internet). Such core network functionality for 5G may include location management functions (LMF(s)) and/or access and mobility management function(s) (AMF(S)) and/or user plane functions (UPF(s)) and/or session management function(s) (SMF(s)). Such core network functionality for LTE may include MME (mobility management entity)/SGW (serving gateway) functionality. Such core network functionality may include SON (self-organizing/optimizing network) functionality. These are merely example functions that may be supported by the network element(s) 190, and note that both 5G and LTE functions might be supported. The RAN node 170 is coupled via a link 131 to the network element 190. The link 131 may be implemented as, e.g., an NG interface for 5G, or an SI interface for LTE, or other suitable interface for other standards. The network element 190 includes one or more processors 175, one or more memories 171, and one or more network interfaces (N/W I/F(s)) 180, interconnected through one or more buses 185. The one or more memories 171 include computer program code 173. Computer program code 173 may include SON and/or MRO functionality 172.

The wireless network 100 may implement network virtualization, which is the process of combining hardware and software network resources and network functionality into a single, software-based administrative entity, or a virtual network. Network virtualization involves platform virtualization, often combined with resource virtualization. Network virtualization is categorized as either external, combining many networks, or parts of networks, into a virtual unit, or internal, providing network-like functionality to software containers on a single system. Note that the virtualized entities that result from the network virtualization are still implemented, at some level, using hardware such as processors 152 or 175 and memories 155 and 171, and also such virtualized entities create technical effects.

The computer readable memories 125, 155, and 171 may be of any type suitable to the local technical environment and may be implemented using any suitable data storage technology, such as semiconductor based memory devices, flash memory, magnetic memory devices and systems, optical memory devices and systems, non-transitory memory, transitory memory, fixed memory and removable memory. The computer readable memories 125, 155, and 171 may be means for performing storage functions. The processors 120, 152, and 175 may be of any type suitable to the local technical environment, and may include one or more of general purpose computers, special purpose computers, microprocessors, digital signal processors (DSPs) and processors based on a multi-core processor architecture, as non-limiting examples. The processors 120, 152, and 175 may be means for performing functions, such as controlling the UE 110, RAN node 170, network element(s) 190, and other functions as described herein.

In general, the various example embodiments of the user equipment 110 can include, but are not limited to, cellular telephones such as smart phones, tablets, personal digital assistants (PDAs) having wireless communication capabilities, portable computers having wireless communication capabilities, image capture devices such as digital cameras having wireless communication capabilities, gaming devices having wireless communication capabilities, music storage and playback devices having wireless communication capabilities, internet appliances including those permitting wireless internet access and browsing, tablets with wireless communication capabilities, head mounted displays such as those that implement virtual/augmented/mixed reality, as well as portable units or terminals that incorporate combinations of such functions. The UE 110 can also be a vehicle such as a car, or a UE mounted in a vehicle, a UAV such as e.g. a drone, or a UE mounted in a UAV. The user equipment 110 may be terminal device, such as mobile phone, mobile device, sensor device etc., the terminal device being a device used by the user or not used by the user.

UE 110, RAN node 170, and/or network element(s) 190, (and associated memories, computer program code and modules) may be configured to implement (e.g. in part) the methods described herein, including a method for multi-TRP through TA acquisition. Thus, computer program code 123, module 140-1, module 140-2, and other elements/features shown in FIG. 1 of UE 110 may implement user equipment related aspects of the examples described herein. Similarly, computer program code 153, module 150-1, module 150-2, and other elements/features shown in FIG. 1 of RAN node 170 may implement gNB/TRP related aspects of the examples described herein. Computer program code 173 and other elements/features shown in FIG. 1 of network element(s) 190 may be configured to implement network element related aspects of the examples described herein.

Having thus introduced a suitable but non-limiting technical context for the practice of the example embodiments, the example embodiments are now described with greater specificity.

The examples described herein are related to a method for multi-TRP through TA acquisition. Further, the examples described herein relate to the early Timing Advance (TA) acquisition of a candidate target cell for Rel-18 L1/L2 triggered mobility (LTM).

Candidate cell and candidate target cell are used interchangeably herein. Serving cell and serving DU are used interchangeably herein. Layer 1/2 (L1/2) Triggered Mobility (LTM) is 3GPP RAN2 agreed term for lower layer (L1/2) mobility. Cell Switch and handover are used interchangeably herein.

L1/L2 triggered mobility (LTM). LTM denoted also as L1/2 inter-cell mobility, is one of the objectives for mobility enhancement in Rel. 18. According to the paradigm description, the decision about the cell change is based on L1 measurements and is made in the MAC layer in the Distributed Unit (DU).

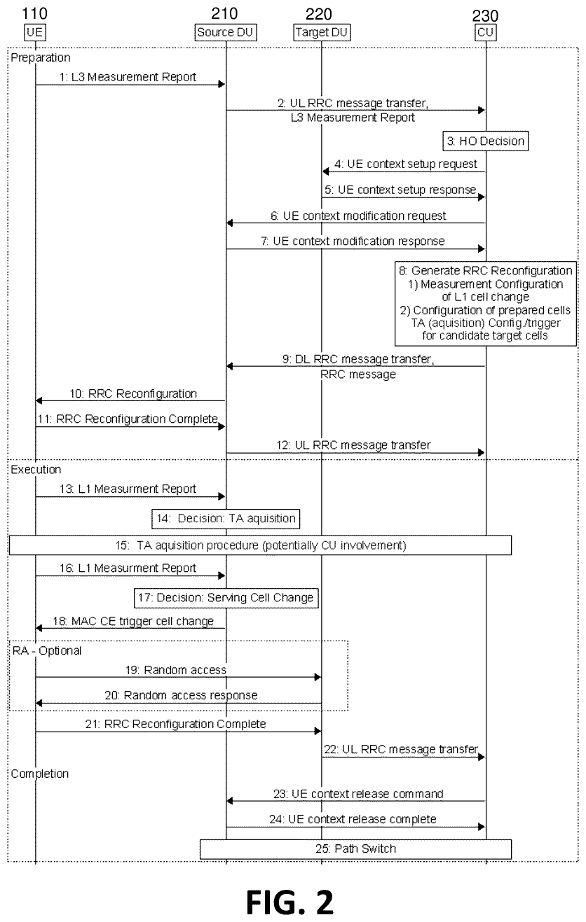

FIG. 2 shows one exemplary message exchange for the inter-DU LTM scenario, captured for disaggregated architecture). The signaling message exchange in FIG. 2 includes UE 110, source DU 210, target DU 220, and CU 230. In brief:

The UE provides the L3 measurements to the source DU, which are forwarded to the Centralized Unit (CU) (steps 1-2). Based on these measurements the CU decides about the cell preparation (HO Decision—step 3) and proceeds in setting up the UE context in the target DU (steps 4-5). CU communicates with the source DU for the modification of the UE context if needed and the provision of the target cell information (i.e., target cell RS configuration, TCI states, etc.) (steps 6-7).

In step 8, the CU creates and forwards the RRC Reconfiguration message to the source DU using a DL RRC Message Transfer and the latter forwards it to the UE (steps 9-10) which may include TA acquisition configurations if CU involvement is needed. UE responds with an RRC Reconfiguration Complete to the CU (steps 11-12).

Based on its configuration, the UE provides the periodic L1 reports to the source DU (step 13).

Based on the received L1 measurement report, the source DU may trigger the UE, e.g., by sending a PDCCH order, to acquire TA for the set of candidate cells (i.e., candidate cells for the handover target cell) (step 14-15). Regarding the mechanism to acquire TA of the candidate cells, in additional RACH-based PDCCH order-based mechanism, additional RACH-less solutions like Rx timing difference based, RACH-less mechanism as in LTE, SRS based TA acquisition can be further studied.

The source-DU/CU and candidate target-DUs/CUs coordinate on the TA acquisition method during LTM preparation phase (e.g., steps 4-5).

The UE continues L1 measurement reporting. Once the source DU decides that the UE should be handed over to a cell (i.e., target cell) of another DU (i.e., target DU) it triggers the cell switch, using a cell switch command (e.g., a MAC CE) (step 16-18). In one solution, the cell switch command may also contain the TA of the target cell.

Then the UE applies the RRC configuration for the target cell of target DU-indicated by the cell switch command (via MAC CE) and switches to the target DU. The UE may be configured to perform Random Access (RA) to the target cell as shown in steps 19-20; however, in other solutions, the UE may be configured to not perform the RA to the target cell as it has already acquired the TA of the target cell. To initiate the communication with the target DU, the UE transmits an RRC Reconfiguration Complete using already configured UL resources to the target cell of target DU, which is forwarded to the CU-CP (steps 21-22).

The CU releases the UE context from the source DU with a UE Context Release Request and performs Path Switch to the new DU (steps 23-25).

### Group Based Beam Reporting and Multiple TRP Operation

For a single DCI based multi PDSCH transmission, a TCI code point in a DCI can correspond to 2 TCI states (maximum of 2 TRPs are supported in 3GPP till now). For a single DCI SDM PDSCH scheme, when 2 TCI states are indicated by a TCI code point and the indicated DMRS ports are from two CDM groups, the first and second TCI states are applied to the first and second indicated CDM groups, respectively. For single DCI FDM/TDM PDSCH schemes, when 2 TCI states are indicated by a TCI code point and corresponding FDM/TDM scheme is pre-configured, the first and second TCI states are applied to the first and second indicated FD/TD resource allocations, respectively.

For a multi-DCI based multi PDSCH transmission, each DCI schedules a respective PDSCH where each PDSCH is transmitted from a separate TRP. For multi-DCI based multi PDSCH transmission, if a UE is configured by higher layer parameter PDCCH-Config that contains two different values of coresetPoolIndex in ControlResourceSet, the UE may expect to receive multiple PDCCHs scheduling fully/partially/non-overlapped PDSCHs in time and frequency domain.

In order to enable mTRP operation, for periodic and semi-persistent CSI Resource Settings, when the UE is configured with groupBasedBeamReporting-r17, the number of CSI Resource Sets configured is S=2, otherwise the number of CSI-RS Resource Sets configured is limited to S=1 [Section 5.2.1.2 from TS 38.214].

If the UE is configured with a CSI-ReportConfig with the higher layer parameter reportQuantity set to ‘cri-RSRP’, ‘ssb-Index-RSRP’, ‘cri-RSRP-Capability [Set] Index’ or ‘ssb-Index-RSRP-Capability [Set] Index’, and if the UE is configured with the higher layer parameter groupBasedBeamReporting-r17, the UE is not required to update measurements for more than 64 CSI-RS and/or SSB resources, and the UE shall report in a single reporting instance nrofReportedRSgroup, if configured, group(s) of two CRIs or SSBRIs selecting one CSI-RS or SSB from each of the two CSI Resource Sets for the report setting, where CSI-RS and/or SSB resources of each group can be received simultaneously by the UE [Section 5.2.1.4.2 from TS 38.214].

### Physical Downlink Control Channel (PDCCH) Order Details [Section 7.3.1.2.1, TS38.212]

Layer 1 Downlink Control Indication (DCI) format 1_0 is used to send a PDCCH order. The following information is transmitted by means of the DCI format 1_0 with CRC scrambled by Cell-Radio Network Temporary Identifier (C-RNTI):

Identifier for DCI formats—1 bit. The value of this bit field is always set to 1, indicating a DL DCI format.

Frequency domain resource assignment—┌log₂(N_{RB}^{DL,BWP}(N_{RB}^{DL,BWP}+1)/2)┐ bits where N_{RB}^{DL,BWP} is the size of the size of CORESET 0 if CORESET 0 is configured for the cell; otherwise, it is the size of initial DL bandwidth part. The value of this field is set to all ones.

Random Access Preamble index—6 bits according to ra-PreambleIndex in Clause 5.1.2 of [8, TS38.321]. It indicates which Random-access preamble to use in case of Contention Free Random Access (CFRA) or the value 000000 in the case of Contention based Random Access (CBRA) procedure. If the Preamble index bit is set as ‘0’ then the UE will trigger a contention-based random-access procedure or else if the Preamble index is >0, then UE will trigger a Contention-free Random-access procedure. Non-zero values are used to allocate the dedicated Prach index (0 to 63) to the UE.

UL/SUL indicator—1 bit. If the value of the “Random Access Preamble index” is not all zeros and if the UE is configured with supplementaryUplink in ServingCellConfig in the cell, this field indicates which UL carrier in the cell to transmit the PRACH according to Table 7.3.1.1.1-1 in TS 38.212; otherwise, this field is reserved

SS/PBCH index—6 bits. If the value of the “Random Access Preamble index” is not all zeros, this field indicates the SS/PBCH that shall be used to determine the RACH occasion for the PRACH transmission; otherwise, this field is reserved.

PRACH Mask index—4 bits. If the value of the “Random Access Preamble index” is not all zeros, this field indicates the RACH occasion associated with the SS/PBCH indicated by “SS/PBCH index” for the PRACH transmission, according to Clause 5.1.1 of [8, TS38.321]; otherwise, this field is reserved.

Reserved bits—12 bits for operation in a cell with shared spectrum channel access in frequency range 1 or when the DCI format is monitored in common search space for operation in a cell in frequency range 2-2; otherwise, 10 bits.

In one example, a UE may obtains the information to acquire multiple timing advance related to each TRP of a multi-TRP. The examples described herein relate to the general interaction with low layer triggered mobility where the TA acquisition is performed with respect to a candidate target cell is not covered. The examples described herein address issues where the serving DU determines to configure a sTRP or mTRP configuration not provided earlier in the configuration. Further, the examples described herein cover handling when TA acquisition with a TRP fails, and using a TA acquisition outcome to determine STRP/mTRP operation.

In Rel-16, intra-cell multi-TRP (mTRP) downlink shared channel transmission was enabled to improve reliability and robustness with both ideal and non-ideal backhaul which was further enhanced in Rel-17 for other downlink (PDCCH) and uplink channels (PUCCH, PUSCH), and inter-cell scenarios as well.

With Rel-18 LTM, in addition to reduced interruption time, one of the motivations is to maintain or even improve transmission efficiency and reliability in the process of fast cell switch. In order to reduce the handover interruption time, the UE could be configured to perform early uplink (UL) synchronization, i.e., TA acquisition for one or more candidate cells (including the target cell) before the cell switch command is received by the UE. This eliminates the need of UL synchronization with the target cell upon cell switch and hence reduces the interruption time.

It may be possible to enhance the early TA acquisition procedure of LTM to multiple TA acquisition for multiple TRPs to enable a smooth transition to mTRP operation. However, the following problems still need to be resolved (1-3):

1. In case if mTRP operation is selected for the UE based on the L1 measurement reports, and then later the early timing advance acquisition for either of the TRPs fails, the serving DU may go on hopelessly triggering the timing advance acquisition in order to enable RACHless operation. This delays the cell switch.

2. In case the target DU has configured a single TRP (sTRP) operation as an LTM configuration but after some time, the UE radio measurements may indicate that it can receive from both TRPs of the target cell. In such a scenario, the UE would be having lower throughput if it is handed over to target DU with a single TRP operation even though high throughput is achievable if a mTRP operation is configured instead. The main issue is, there is no mechanism to indicate the possible switch to an mTRP operation to the target DU.

A similar problem formulation can be based from timing advance point of view. UE might be configured with LTM for a single TRP operation. UE may acquire (e.g., for non-collocated carrier aggregation) the timing advance for a TRP of a cell that can be used for LTM for a multi TRP operation. Again, there is no mechanism to indicate the possible switch to mTRP to the target DU.

The examples described herein relate to enhancements for LTM with multi-TRP. This is achieved via enhancing the serving DU behavior and serving DU to CU signaling (1-2):

1. The serving DU is enhanced to monitor the possibility to configure UE with multiTRP when only a singleTRP configuration is configured to the UE initially. Such a possibility is indicated by the CU to DU. In one embodiment the CU (in coordination with the target-DU) provides the DU with the information of beam pairs (or PCIs or radio resource sets) can be used for m-TRP operation. Hence by monitoring the received measurement results the DU can decide between s-TRP and m-TRP.

In one example, the DU may determine based DL RS indicated by the TCI state and received measurements whether the UE can be configured with mTRP operation in the target cell.

2. But also the reverse, if multi-TRP is configured the serving DU is enhanced to monitor the possibility to initiate single TRP instead of mTRP, or multiTRP via triggering the RACH towards one leg and accessing one leg RACHless.

The serving DU monitors the L1-RSRP measurements to indicate the possibility of multiTRP configuration and involved TRPs (cells) to the CU. The DU monitors the outcome of TA acquisition procedure, (i.e., if UE fails to acquire one of multi TRPs), DU indicates to CU that single TRP configuration can be better for the UE.

Depending on the UE capability, the m-TRP operation maybe conditioned to the TA difference value between two TRPs (TCI-states). E.g., the s-DU/CU may configure the UE with s-TRP if the TA differences between two TRPs is below CP.

In one example, the CU may provide the DU the TAG ID association of one or more TCI states (this may be used to determine whether one or two TA values or TA value per TRP is needed in mTRP operation. The DU may determine based DL RS indicated by the TCI state and received measurements whether the UE can/should be configured with mTRP operation in the target cell.

In additional embodiment, the UE may be configured with group-based beam reporting (GBBR), and the DU may trigger TA acquisition (and later on m-TRP operation) for the beam-pair reported by the UE as part of GBBR report.

Using the indication the CU configures mTRP or a sTRP operation to the UE. Or if the UE is already configured with both mTRP and sTRP operation the serving DU can implicitly/explicitly indicate to initiate sTRP or mTRP operation using the timing advance acquisition information at the UE side.

In one embodiment, (for multi-TRP with same PCIs) the trigger of TA acquisition for two TCI-states may implicitly indicates the m-TRP operation to the UE. And the trigger of TA acquisition for one TCI-state may imply s-TRP operation. A similar can be applied for target-DU, where in case of receiving two TA RA from one UE on two TCI-states (RO) implies the m-TRP configuration/condition have been met the UE.

In another embodiment, the UE is configured to apply m-TRP configurations if L1/L3 measurement results are above a certain threshold.

In one embodiment the UE may be configured to indicate the stronger measured TRP (among the measured TRPs) to the target-DU/CU for example using a different preamble for the stronger TRP.

In one example, for implicit indication, if the cell switch command includes one TCI state (beam indication), the UE assumes single TRP operation i.e., applies single TRP configuration upon cell switch

In one example, for implicit indication, if the cell switch command includes two TCI states (beam indication), the UE assumes multiple TRP operation i.e., applies multi TRP configuration upon cell switch.

In another example, if the UE is indicated (explicitly) with mTRP operation, but the cell switch command includes one TCI state ID, the UE assumes mTRP operation but applies the indicated TCI state for mTRP operation but assumes to receive beam indication for the second TRP after cell switch.

In case of direct TA value transmission (RAR) from the target-DU to the UE, the RA response may include implicit/explicit indication for s-TRP/m-TRP operation. The UE then may indicate this to the CU or source-DU. Similarly, this information can be provided to source DU as well. So no need for UE to report to the source DU.

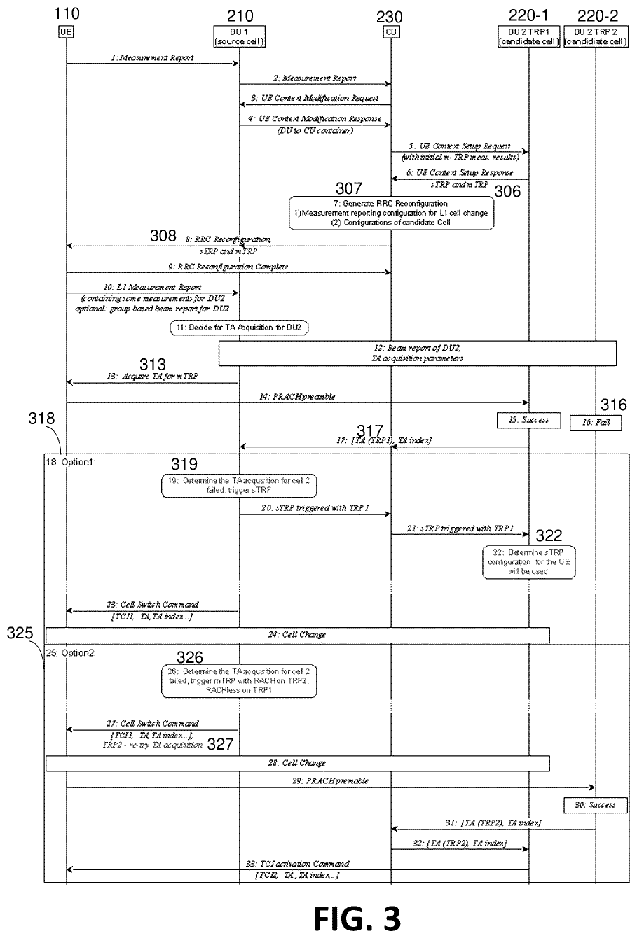

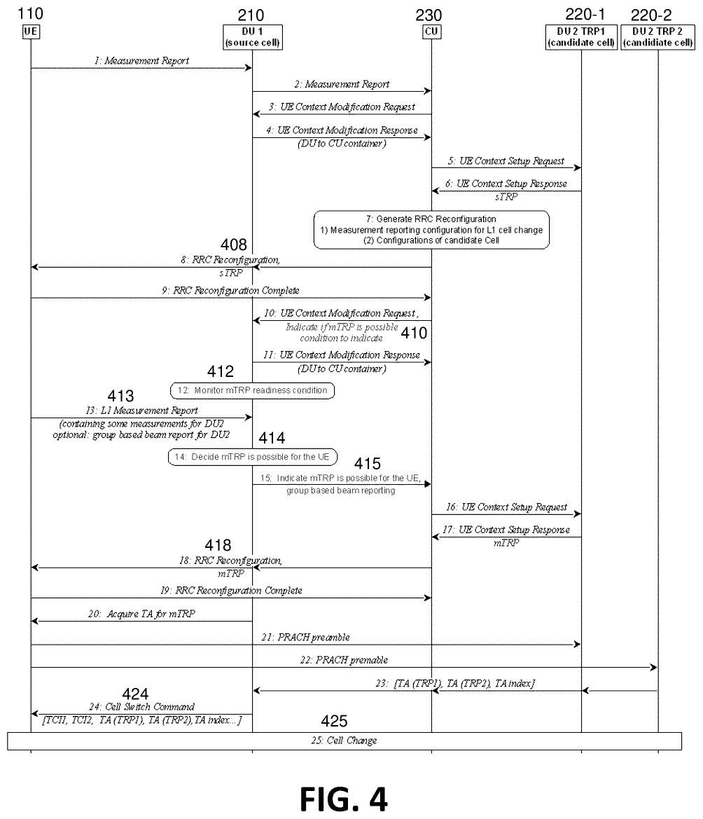

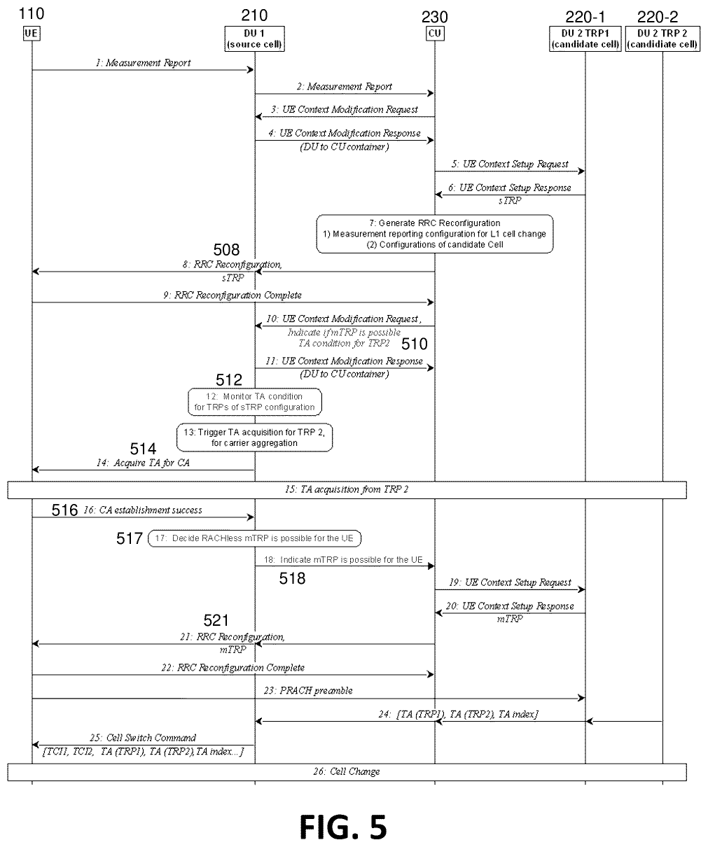

FIG. 3, FIG. 4, and FIG. 5 each show a message sequence chart between UE 110, DU 1 (source cell) 210, CU 230, DU 2 TRP 1 (candidate cell) 220-1, and DU 2 TRP 2 (candidate cell) 220-2, based on the examples described herein. DU 2 in some examples is one network node having two transmission reception points, namely TRP 1 and TRP 2, and DU 2 in some examples represents two network nodes, where a first network node of the two network nodes comprises TRP 1 and a second network node of the two network nodes comprises TRP 2.

FIG. 3 is a message sequence chart for triggering sTRP operation or mTRP operation with re-trial on RACH.

UE 110 is configured with both sTRP and mTRP operation for LTM (306, 308).

The Target-DU/CU provide early TA acquisition configuration for m-TRP and s-TRP operation (307).

The DU (210) triggers the TA acquisition (313) on both TRPs. Two TRPs have same PCI and have different PCI. TA acquisition fails (316) on one TRP (220-2).

The DU (210) is aware of the TA acquisition failure as the TA of only one TRP is communicated (317) to the DU 210 by the CU 230.

The DU 210 is either configured by the CU 230, or the target DU, or determines itself (319, 326) to indicate sTRP operation (option 1 318) or mTRP operation with RACHless operation on one TRP (220-1) and TA acquisition on other TRP (220-2) (option 2 325). DU (210) indicates the triggered behavior to DU2 TRP1 (220-1) and TRP2 (220-2). So the resources for the TRP2 (220-2) can be released and TRP1 (220-1) can do required procedures such as initiation of monitoring of the first uplink resource from the UE side 110. Such an indication can be assumed by the TRP 1 (220-1) or TRP 2 (220-2), i.e., once DU2 220-1 indicates the timing advance for TRP1 (220-1) within a time period it can assume that the sTRP can be triggered.

As further indicated in FIG. 3, at 322 the DU 2 TRP1 (candidate cell) 220-1 determines that an sTRP configuration for the UE 110 will be used, and at 327 the DU 210 transmits a message to the UE 110 to retry TA acquisition for TRP2.

The indication to perform a cell switch with multiple transmission reception point operation while retrying to acquire the timing advance for the second candidate cell (such as for example the indication transmitted at 327), can be explicit or implicit. For example, in case of implicit indication, a beam indication associated with the first candidate cell (first TRP, for example DU 2 TRP 1 220-1) may have an associated TA given in the cell switch command whereas the beam indication given for the second candidate cell (second TRP, for example DU 2 TRP 2 220-2) may not have any valid associated TA value, e.g., no value or an specific value indicating an invalid TA value, given in the cell switch command.

FIG. 4 is a message sequence chart for triggering mTRP configuration after UE measurements.

CU 230 configures the UE 110 with sTRP operation for LTM (408). At 410, CU 230 indicates to the serving DU 210 about the mTRP configuration in terms of measurement reporting (mapping between RSs (SSB/CSI-RSs) and target DU TRPs (e.g. 220-1, 220-2)) to determine possible mTRP operation based on the measurement reporting.

In case UE reports (413) indicating simultaneous reception of multiple beams from multiple TRPs, at 414 serving DU 210 determines mTRP operation is possible. Regular L1 measurement from the candidate cell with a larger set (RSs from multiple TRPs) may be configured for LTM. Measurement RS of a candidate cell does not need to be configured for a specific neighboring cell's UEs; instead for dynamic switching among a set of neighboring cells, a larger set (RSs from multiple TRPs) may be configured applicable for multiple neighboring cells. Then a legacy reporting can be used e.g., a cell may transmit SSBs from different TRPs in a TDM fashion and receive reports from the UE to find if the UE can hear different TRPs or not.

At 415, serving DU 210 sends an indication to CU 230, and CU 230 configures mTRP operation for LTM to the UE (418). Once UE 110 is configured, the mTRP LTM can be triggered (424, 425), once the measurements are strong enough. FIG. 4 further shows the DU 1 (source cell) 210 monitoring an mTRP readiness condition at 412.

FIG. 5 is a message sequence chart for triggering mTRP configuration after TA acquisition.

CU 230 configures the UE 110 with sTRP operation for LTM (508). CU 230 indicates (for example at 510) to the serving DU 210 that it should monitor the timing advance of a list of TRPs to determine mTRP operation.

At 512, serving DU 210 starts monitoring the timing advance maintenance at the UE side. At 514, the serving DU 210 indicates to the UE 110 to acquire timing advance from TRP 2 (220-2), for another operation, i.e., carrier aggregation.

At 516, UE 110 reports successful timing advance acquisition.

At 517, DU 210 determines that RACHless switch to these TRPs for mTRP operation is possible.

At 518, serving DU 210 sends an indication to CU 230, and CU 230 configures (521) mTRP operation for LTM to the UE 110.

Once UE 110 is configured, the mTRP LTM can be triggered (525, 526), once the measurements are strong enough.

The examples described herein may be standardized for Rel. 18, and are related to LTM supporting UEs.

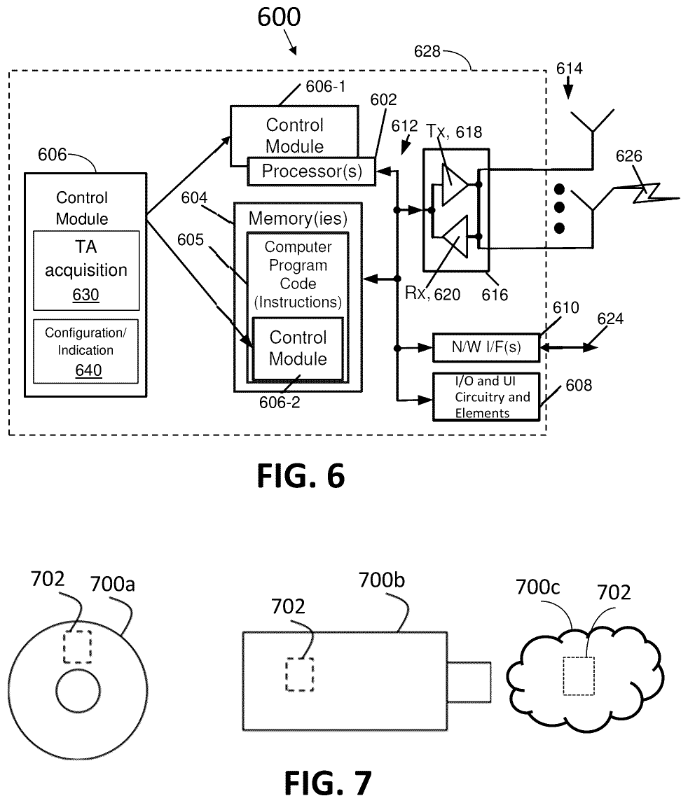

FIG. 6 is an example apparatus 600, which may be implemented in hardware, configured to implement the examples described herein. The apparatus 600 comprises at least one processor 602 (e.g. an FPGA and/or CPU), one or more memories 604 including computer program code 605, the computer program code 605 having instructions to carry out the methods described herein, wherein the at least one memory 604 and the computer program code 605 are configured to, with the at least one processor 602, cause the apparatus 600 to implement circuitry, a process, component, module, or function (implemented with control module 606) to implement the examples described herein, including a method for multi-TRP through TA acquisition. The memory 604 may be a non-transitory memory, a transitory memory, a volatile memory (e.g. RAM), or a non-volatile memory (e.g. ROM). TA acquisition 630 and configuration/indication 640 of the control module implement the herein described aspects related to a method for multi-TRP through TA acquisition.

The apparatus 600 includes a display and/or I/O interface 608, which includes user interface (UI) circuitry and elements, that may be used to display aspects or a status of the methods described herein (e.g., as one of the methods is being performed or at a subsequent time), or to receive input from a user such as with using a keypad, camera, touchscreen, touch area, microphone, biometric recognition, one or more sensors, etc. The apparatus 600 includes one or more communication e.g. network (N/W) interfaces (I/F(s)) 610. The communication I/F(s) 610 may be wired and/or wireless and communicate over the Internet/other network(s) via any communication technique including via one or more links 624. The link(s) 624 may be the link(s) 131 and/or 176 from FIG. 1. The link(s) 131 and/or 176 from FIG. 1 may also be implemented using transceiver(s) 616 and corresponding wireless link(s) 626. The communication I/F(s) 610 may comprise one or more transmitters or one or more receivers.

The transceiver 616 comprises one or more transmitters 618 and one or more receivers 620. The transceiver 616 and/or communication I/F(s) 610 may comprise standard well-known components such as an amplifier, filter, frequency-converter, (de) modulator, and encoder/decoder circuitries and one or more antennas, such as antennas 614 used for communication over wireless link 626.

The control module 606 of the apparatus 600 comprises one of or both parts 606-1 and/or 606-2, which may be implemented in a number of ways. The control module 606 may be implemented in hardware as control module 606-1, such as being implemented as part of the one or more processors 602. The control module 606-1 may be implemented also as an integrated circuit or through other hardware such as a programmable gate array. In another example, the control module 606 may be implemented as control module 606-2, which is implemented as computer program code (having corresponding instructions) 605 and is executed by the one or more processors 602. For instance, the one or more memories 604 store instructions that, when executed by the one or more processors 602, cause the apparatus 600 to perform one or more of the operations as described herein. Furthermore, the one or more processors 602, the one or more memories 604, and example algorithms (e.g., as flowcharts and/or signaling diagrams), encoded as instructions, programs, or code, are means for causing performance of the operations described herein.

The apparatus 600 to implement the functionality of control 606 may be UE 110, RAN node 170 (e.g. gNB), or network element(s) 190. Thus, processor 602 may correspond to processor(s) 120, processor(s) 152 and/or processor(s) 175, memory 604 may correspond to one or more memories 125, one or more memories 155 and/or one or more memories 171, computer program code 605 may correspond to computer program code 123, computer program code 153, and/or computer program code 173, control module 606 may correspond to module 140-1, module 140-2, module 150-1, and/or module 150-2, and communication I/F(s) 610 and/or transceiver 616 may correspond to transceiver 130, antenna(s) 128, transceiver 160, antenna(s) 158, N/W I/F(s) 161, and/or N/W I/F(s) 180. Alternatively, apparatus 600 and its elements may not correspond to either of UE 110, RAN node 170, or network element(s) 190 and their respective elements, as apparatus 600 may be part of a self-organizing/optimizing network (SON) node or other node, such as a node in a cloud.

Apparatus 600 may also correspond to DU 1 (source cell) 210, CU 230, DU 2, DU 2 TRP1 (candidate cell) 220-1, or DU 2 TRP 2 (candidate cell) 220-2.

The apparatus 600 may also be distributed throughout the network (e.g. 100) including within and between apparatus 600 and any network element (such as a network control element (NCE) 190 and/or the RAN node 170 and/or UE 110).

Interface 612 enables data communication and signaling between the various items of apparatus 600, as shown in FIG. 6. For example, the interface 612 may be one or more buses such as address, data, or control buses, and may include any interconnection mechanism, such as a series of lines on a motherboard or integrated circuit, fiber optics or other optical communication equipment, and the like. Computer program code (e.g. instructions) 605, including control 606 may comprise object-oriented software configured to pass data or messages between objects within computer program code 605. The apparatus 600 need not comprise each of the features mentioned, or may comprise other features as well. The various components of apparatus 600 may at least partially reside in a common housing 628, or a subset of the various components of apparatus 600 may at least partially be located in different housings, which different housings may include housing 628.

FIG. 7 shows a schematic representation of non-volatile memory media 700a (e.g. computer/compact disc (CD) or digital versatile disc (DVD)) and 700b (e.g. universal serial bus (USB) memory stick) and 700c (e.g. cloud storage for downloading instructions and/or parameters 702 or receiving emailed instructions and/or parameters 702) storing instructions and/or parameters 702 which when executed by a processor allows the processor to perform one or more of the steps of the methods described herein.

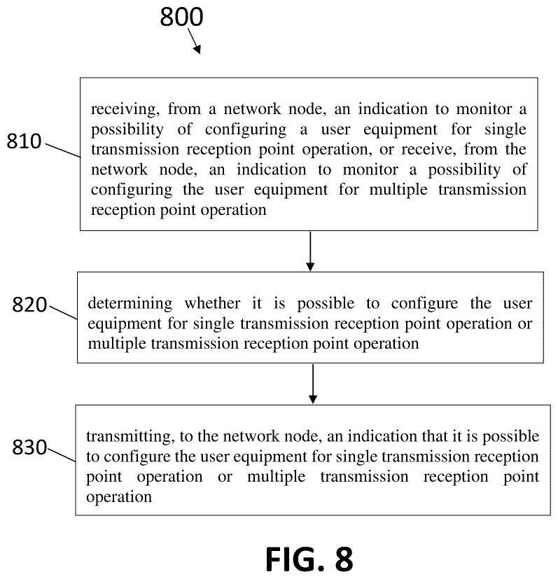

FIG. 8 is an example method 800, based on the example embodiments described herein. At 810, the method includes receiving, from a network node, an indication to monitor a possibility of configuring a user equipment for single transmission reception point operation, or receive, from the network node, an indication to monitor a possibility of configuring the user equipment for multiple transmission reception point operation. At 820, the method includes determining whether it is possible to configure the user equipment for single transmission reception point operation or multiple transmission reception point operation. At 830, the method includes transmitting, to the network node, an indication that it is possible to configure the user equipment for single transmission reception point operation or multiple transmission reception point operation. Method 800 may be performed by DU 1 210, DU 195, RAN node 170, one or more network elements 190, or apparatus 600.

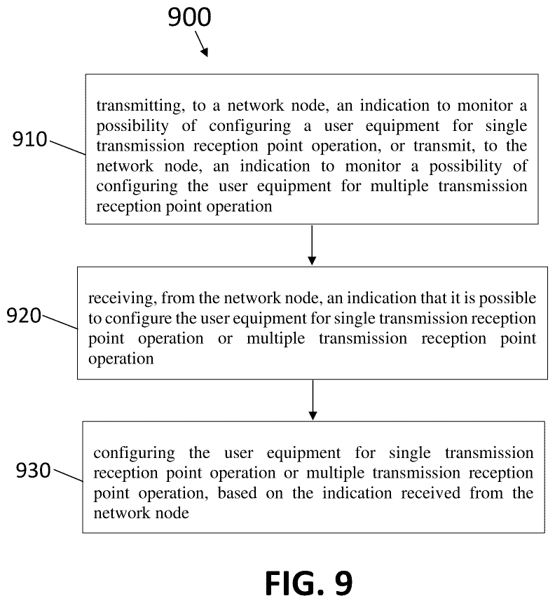

FIG. 9 is an example method 900, based on the example embodiments described herein. At 910, the method includes transmitting, to a network node, an indication to monitor a possibility of configuring a user equipment for single transmission reception point operation, or transmit, to the network node, an indication to monitor a possibility of configuring the user equipment for multiple transmission reception point operation. At 920, the method includes receiving, from the network node, an indication that it is possible to configure the user equipment for single transmission reception point operation or multiple transmission reception point operation. At 930, the method includes configuring the user equipment for single transmission reception point operation or multiple transmission reception point operation, based on the indication received from the network node. Method 900 may be performed by CU 230, CU 196, RAN node 170, one or more network elements 190, or apparatus 600.

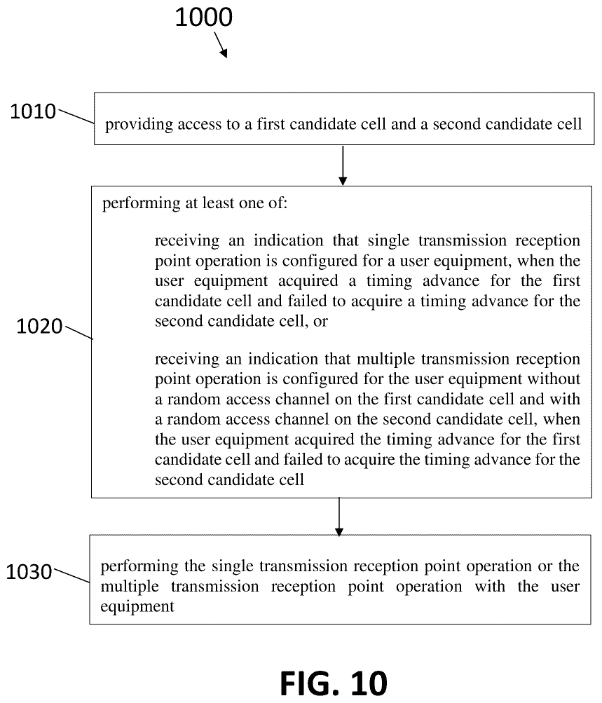

FIG. 10 is an example method 1000, based on the example embodiments described herein. At 1010, the method includes providing access to a first candidate cell and a second candidate cell. At 1020, the method includes performing at least one of: receiving an indication that single transmission reception point operation is configured for a user equipment, when the user equipment acquired a timing advance for the first candidate cell and failed to acquire a timing advance for the second candidate cell, or receiving an indication that multiple transmission reception point operation is configured for the user equipment without a random access channel on the first candidate cell and with a random access channel on the second candidate cell, when the user equipment acquired the timing advance for the first candidate cell and failed to acquire the timing advance for the second candidate cell. At 1030, the method includes performing the single transmission reception point operation or the multiple transmission reception point operation with the user equipment. Method 1000 may be performed by DU 2 TRP1 220-1, DU 2 TRP 2 220-2, DU 195, RAN node 170, one or more network elements 190, or apparatus 600.

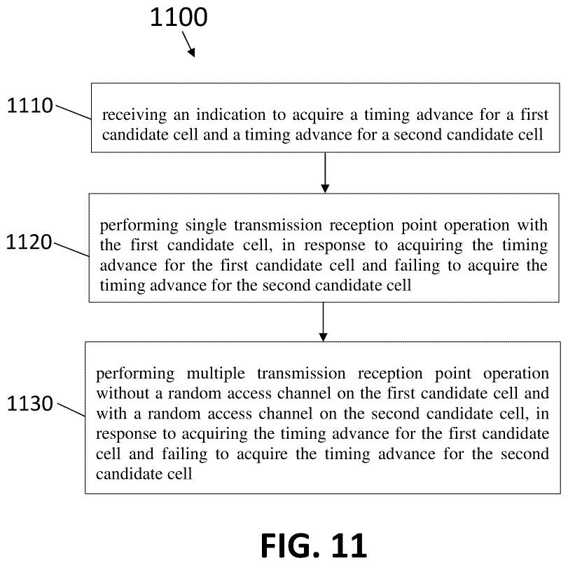

FIG. 11 is an example method 1100, based on the example embodiments described herein. At 1110, the method includes receiving an indication to acquire a timing advance for a first candidate cell and a timing advance for a second candidate cell. At 1120, the method includes performing single transmission reception point operation with the first candidate cell, in response to acquiring the timing advance for the first candidate cell and failing to acquire the timing advance for the second candidate cell. At 1130, the method includes performing multiple transmission reception point operation without a random access channel on the first candidate cell and with a random access channel on the second candidate cell, in response to acquiring the timing advance for the first candidate cell and failing to acquire the timing advance for the second candidate cell. Method 1100 may be performed by UE 110 or apparatus 600.

The following examples are provided and described herein.

Example 1. An apparatus including: at least one processor; and at least one memory storing instructions that, when executed by the at least one processor, cause the apparatus at least to: receive, from a network node, an indication to monitor a possibility of configuring a user equipment for single transmission reception point operation, or receive, from the network node, an indication to monitor a possibility of configuring the user equipment for multiple transmission reception point operation; determine whether it is possible to configure the user equipment for single transmission reception point operation or multiple transmission reception point operation; and transmit, to the network node, an indication that it is possible to configure the user equipment for single transmission reception point operation or multiple transmission reception point operation.

Example 2. The apparatus of example 1, wherein the instructions, when executed by the at least one processor, cause the apparatus at least to: configure the user equipment to acquire a timing advance for a first candidate cell and a timing advance for a second candidate cell; determine that the user equipment acquired the timing advance for the first candidate call and failed to acquire the timing advance for the second candidate cell; and perform at least one of: indicate, to the network node, single transmission reception point operation with the first candidate cell for the user equipment, or determine to configure the user equipment for multiple transmission reception point operation with a random access channel with the second candidate cell and without a random access channel with the first candidate cell.

Example 3. The apparatus of example 2, wherein the instructions, when executed by the at least one processor, cause the apparatus at least to: transmit, to the user equipment, a cell switch indication to: perform a cell switch with multiple transmission reception point operation while retrying to acquire the timing advance for the second candidate cell.

Example 4. The apparatus of example 3, wherein the cell switch indication transmitted to the user equipment to perform the cell switch with multiple transmission reception point operation while retrying to acquire the timing advance for the second candidate cell comprises an explicit indication or an implicit indication.

Example 5. The apparatus of example 4, wherein the cell switch indication comprises the implicit indication when a beam indication associated with the second candidate cell does not comprise a valid timing advance value, wherein the beam indication associated with the second candidate cell is within the cell switch indication.

Example 6. The apparatus of example 5, wherein a beam indication associated with the first candidate cell comprises a valid timing advance value, wherein the beam indication associated with the first candidate cell is within the cell switch indication.

Example 7. The apparatus of example 6, wherein the first candidate cell is associated with a first transmission reception point, and the second candidate cell is associated with a second transmission reception point.

Example 8. The apparatus of any of examples 1 to 7, wherein the instructions, when executed by the at least one processor, cause the apparatus at least to: transmit an indication that single transmission reception point operation is configured for the user equipment, or transmit an indication that multiple transmission reception point operation is configured for the user equipment without a random access channel on a first candidate cell and with a random access channel on a second candidate cell.

Example 9. The apparatus of example 8, wherein the indication that single transmission reception point operation is configured for the user equipment, and the indication that multiple transmission reception point operation is configured for the user equipment without a random access channel on the first candidate cell and with a random access channel on the second candidate cell, are transmitted to the network node or to a distributed unit associated with the first candidate cell and the second candidate cell.

Example 10. The apparatus of any of examples 8 to 9, wherein the instructions, when executed by the at least one processor, cause the apparatus at least to: receive a configuration to transmit the indication that single transmission reception point operation is configured for the user equipment, and to transmit the indication that multiple transmission reception point operation is configured for the user equipment without a random access channel on a first candidate cell and with a random access channel on a second candidate cell.

Example 11. The apparatus of example 10, wherein the configuration is received from the network node or a distributed unit that provides access to the first candidate cell and the second candidate cell.

Example 12. The apparatus of any of examples 1 to 11, wherein the instructions, when executed by the at least one processor, cause the apparatus at least to: receive, from the user equipment, an indication of successful timing advance acquisition; and determine that multiple transmission reception operation is possible for the user equipment, based on the indication of successful timing advance acquisition; and indicate, to the network node, that multiple transmission reception operation is possible for the user equipment.

Example 13. The apparatus of any of examples 1 to 12, wherein the instructions, when executed by the at least one processor, cause the apparatus at least to: receive, from the network node, a configuration for measurement reporting related to multiple transmission reception point operation; receive at least one measurement from the user equipment; and determine whether it is possible to configure the user equipment for multiple transmission reception point operation, based on the at least one measurement and the configuration for measurement reporting.

Example 14. The apparatus of example 13, wherein the configuration for measurement reporting comprises a mapping between reference signals and target transmission reception points of a distributed unit.

Example 15. The apparatus of any of examples 13 to 14, wherein the instructions, when executed by the at least one processor, cause the apparatus at least to: receive, from the user equipment based on the at least one measurement, an indication of reception of multiple beams from multiple transmission reception points; determine that it is possible to configure the user equipment for multiple transmission reception point operation, based on the indication of reception of multiple beams from multiple transmission reception points received from the user equipment.

Example 16. The apparatus of any of examples 1 to 15, wherein the instructions, when executed by the at least one processor, cause the apparatus at least to: determine that multiple timing advances are available at the user equipment; and determine that it is possible to configure the user equipment for multiple transmission reception point operation due to the multiple timing advances being available at the user equipment.

Example 17. The apparatus of any of examples 1 to 16, wherein the apparatus comprises a distributed unit that provides access to a source cell for the user equipment, and the network node comprises a central unit.

Example 18. An apparatus including: at least one processor; and at least one memory storing instructions that, when executed by the at least one processor, cause the apparatus at least to: transmit, to a network node, an indication to monitor a possibility of configuring a user equipment for single transmission reception point operation, or transmit, to the network node, an indication to monitor a possibility of configuring the user equipment for multiple transmission reception point operation; receive, from the network node, an indication that it is possible to configure the user equipment for single transmission reception point operation or multiple transmission reception point operation; and configure the user equipment for single transmission reception point operation or multiple transmission reception point operation, based on the indication received from the network node.

Example 19. The apparatus of example 18, wherein the instructions, when executed by the at least one processor, cause the apparatus at least to: transmit, to the network node, an indication to monitor whether the user equipment acquired a timing advance for a first candidate call and for a second candidate cell.

Example 20. The apparatus of any of examples 18 to 19, wherein the instructions, when executed by the at least one processor, cause the apparatus at least to: receive, from the network node, an indication of single transmission reception point operation with a first candidate cell for the user equipment, when the user equipment acquired a timing advance for the first candidate cell and failed to acquire a timing advance for a second candidate cell, or receive, from the network node, an indication of multiple transmission reception point operation for the user equipment with the first candidate cell and the second candidate cell, when the user equipment acquired a timing advance for the first candidate cell and failed to acquire the timing advance for the second candidate cell.

Example 21. The apparatus of example 20, wherein the indication of multiple transmission reception point operation for the user equipment indicates that multiple transmission reception point operation is configured for the user equipment without a random access channel on the first candidate cell and with a random access channel on the second candidate cell.

Example 22. The apparatus of any of examples 18 to 21, wherein the instructions, when executed by the at least one processor, cause the apparatus at least to: transmit, to the network node, a configuration to transmit an indication that single transmission reception point operation is configured for the user equipment, and to transmit an indication that multiple transmission reception point operation is configured for the user equipment without a random access channel on a first candidate cell and with a random access channel on a second candidate cell.

Example 23. The apparatus of any of examples 18 to 22, wherein the instructions, when executed by the at least one processor, cause the apparatus at least to: receive, from the network node, an indication that multiple transmission reception operation is possible for the user equipment; and configure the user equipment for multiple transmission reception point operation, based on the received indication that multiple transmission reception operation is possible for the user equipment.

Example 24. The apparatus of any of examples 18 to 23, wherein the instructions, when executed by the at least one processor, cause the apparatus at least to: transmit, to the network node, a configuration for measurement reporting related to multiple transmission reception point operation, wherein the configuration for measurement reporting is configured to be used for a determination of whether multiple transmission reception point operation is possible for the user equipment.

Example 25. The apparatus of example 24, wherein the configuration for measurement reporting comprises a mapping between reference signals and target transmission reception points of a distributed unit.

Example 26. The apparatus of any of examples 18 to 25, wherein the apparatus comprises a central unit, and the network node comprises a distributed unit.

Example 27. An apparatus including: at least one processor; and at least one memory storing instructions that, when executed by the at least one processor, cause the apparatus at least to: provide access to a first candidate cell and a second candidate cell; and perform at least one of: receive an indication that single transmission reception point operation is configured for a user equipment, when the user equipment acquired a timing advance for the first candidate cell and failed to acquire a timing advance for the second candidate cell, or receive an indication that multiple transmission reception point operation is configured for the user equipment without a random access channel on the first candidate cell and with a random access channel on the second candidate cell, when the user equipment acquired the timing advance for the first candidate cell and failed to acquire the timing advance for the second candidate cell; and perform the single transmission reception point operation or the multiple transmission reception point operation with the user equipment.

Example 28. The apparatus of example 27, wherein the instructions, when executed by the at least one processor, cause the apparatus at least to: release at least one resource associated with the second candidate cell.

Example 29. The apparatus of any of examples 27 to 28, wherein the instructions, when executed by the at least one processor, cause the apparatus at least to: transmit, to a distributed unit associated with a source cell, a configuration to perform at least one of: a transmission of the indication that single transmission reception point operation is configured for the user equipment, or a transmission of the indication that multiple transmission reception point operation is configured for the user equipment without the random access channel on the first candidate cell and with the random access channel on the second candidate cell.

Example 30. The apparatus of any of examples 27 to 29, wherein the apparatus comprises a distributed unit having at least two transmission reception points.

Example 31. An apparatus including: at least one processor; and at least one memory storing instructions that, when executed by the at least one processor, cause the apparatus at least to: receive an indication to acquire a timing advance for a first candidate cell and a timing advance for a second candidate cell; perform single transmission reception point operation with the first candidate cell, in response to acquiring the timing advance for the first candidate cell and failing to acquire the timing advance for the second candidate cell; and perform multiple transmission reception point operation without a random access channel on the first candidate cell and with a random access channel on the second candidate cell, in response to acquiring the timing advance for the first candidate cell and failing to acquire the timing advance for the second candidate cell.

Example 32. The apparatus of example 31, wherein the indication to acquire the timing advance for the first candidate cell and the timing advance for the second candidate cell is received from a distributed unit that provides access to a source cell for the user equipment.

Example 33. The apparatus of any of examples 31 to 32, wherein the instructions, when executed by the at least one processor, cause the apparatus at least to: receive, from a network, a cell switch indication to: perform a cell switch with multiple transmission reception point operation while retrying to acquire the timing advance for the second candidate cell.

Example 34. The apparatus of example 33, wherein the cell switch indication received from the network to perform the cell switch with multiple transmission reception point operation while retrying to acquire the timing advance for the second candidate cell comprises an explicit indication or an implicit indication.

Example 35. The apparatus of example 34, wherein the cell switch indication comprises the implicit indication when a beam indication associated with the second candidate cell does not comprise a valid timing advance value, wherein the beam indication associated with the second candidate cell is within the cell switch indication.

Example 36. The apparatus of example 35, wherein a beam indication associated with the first candidate cell comprises a valid timing advance value, wherein the beam indication associated with the first candidate cell is within the cell switch indication.

Example 37. The apparatus of example 36, wherein the first candidate cell is associated with a first transmission reception point, and the second candidate cell is associated with a second transmission reception point.

Example 38. The apparatus of any of examples 31 to 37, wherein the instructions, when executed by the at least one processor, cause the apparatus at least to: switch from a source cell to at least one of the first candidate cell or the second candidate cell, in response to acquiring at least one of: the timing advance for the first candidate cell, or the timing advance for the second candidate cell, or a cell change command indicating to perform the multiple transmission reception point operation via re-trial of a random access channel procedure.

Example 39. The apparatus of any of examples 31 to 38, wherein the apparatus comprises a user equipment.

Example 40. A method including: receiving, from a network node, an indication to monitor a possibility of configuring a user equipment for single transmission reception point operation, or receive, from the network node, an indication to monitor a possibility of configuring the user equipment for multiple transmission reception point operation; determining whether it is possible to configure the user equipment for single transmission reception point operation or multiple transmission reception point operation; and transmitting, to the network node, an indication that it is possible to configure the user equipment for single transmission reception point operation or multiple transmission reception point operation.

Example 41. A method including: transmitting, to a network node, an indication to monitor a possibility of configuring a user equipment for single transmission reception point operation, or transmit, to the network node, an indication to monitor a possibility of configuring the user equipment for multiple transmission reception point operation; receiving, from the network node, an indication that it is possible to configure the user equipment for single transmission reception point operation or multiple transmission reception point operation; and configuring the user equipment for single transmission reception point operation or multiple transmission reception point operation, based on the indication received from the network node.

Example 42. A method including: providing access to a first candidate cell and a second candidate cell; and performing at least one of: receiving an indication that single transmission reception point operation is configured for a user equipment, when the user equipment acquired a timing advance for the first candidate cell and failed to acquire a timing advance for the second candidate cell, or receiving an indication that multiple transmission reception point operation is configured for the user equipment without a random access channel on the first candidate cell and with a random access channel on the second candidate cell, when the user equipment acquired the timing advance for the first candidate cell and failed to acquire the timing advance for the second candidate cell; and performing the single transmission reception point operation or the multiple transmission reception point operation with the user equipment.

Example 43. A method including: receiving an indication to acquire a timing advance for a first candidate cell and a timing advance for a second candidate cell; performing single transmission reception point operation with the first candidate cell, in response to acquiring the timing advance for the first candidate cell and failing to acquire the timing advance for the second candidate cell; and performing multiple transmission reception point operation without a random access channel on the first candidate cell and with a random access channel on the second candidate cell, in response to acquiring the timing advance for the first candidate cell and failing to acquire the timing advance for the second candidate cell.

Example 44. An apparatus including: means for receiving, from a network node, an indication to monitor a possibility of configuring a user equipment for single transmission reception point operation, or receive, from the network node, an indication to monitor a possibility of configuring the user equipment for multiple transmission reception point operation; means for determining whether it is possible to configure the user equipment for single transmission reception point operation or multiple transmission reception point operation; and means for transmitting, to the network node, an indication that it is possible to configure the user equipment for single transmission reception point operation or multiple transmission reception point operation.

Example 45. An apparatus including: means for transmitting, to a network node, an indication to monitor a possibility of configuring a user equipment for single transmission reception point operation, or transmit, to the network node, an indication to monitor a possibility of configuring the user equipment for multiple transmission reception point operation; means for receiving, from the network node, an indication that it is possible to configure the user equipment for single transmission reception point operation or multiple transmission reception point operation; and means for configuring the user equipment for single transmission reception point operation or multiple transmission reception point operation, based on the indication received from the network node.

Example 46. An apparatus including: means for providing access to a first candidate cell and a second candidate cell; and means for performing at least one of: receiving an indication that single transmission reception point operation is configured for a user equipment, when the user equipment acquired a timing advance for the first candidate cell and failed to acquire a timing advance for the second candidate cell, or receiving an indication that multiple transmission reception point operation is configured for the user equipment without a random access channel on the first candidate cell and with a random access channel on the second candidate cell, when the user equipment acquired the timing advance for the first candidate cell and failed to acquire the timing advance for the second candidate cell; and means for performing the single transmission reception point operation or the multiple transmission reception point operation with the user equipment.

Example 47. An apparatus including: means for receiving an indication to acquire a timing advance for a first candidate cell and a timing advance for a second candidate cell; means for performing single transmission reception point operation with the first candidate cell, in response to acquiring the timing advance for the first candidate cell and failing to acquire the timing advance for the second candidate cell; and means for performing multiple transmission reception point operation without a random access channel on the first candidate cell and with a random access channel on the second candidate cell, in response to acquiring the timing advance for the first candidate cell and failing to acquire the timing advance for the second candidate cell.

Example 48. A non-transitory program storage device readable by a machine, tangibly embodying a program of instructions executable by the machine for performing operations, the operations including: receiving, from a network node, an indication to monitor a possibility of configuring a user equipment for single transmission reception point operation, or receive, from the network node, an indication to monitor a possibility of configuring the user equipment for multiple transmission reception point operation; determining whether it is possible to configure the user equipment for single transmission reception point operation or multiple transmission reception point operation; and transmitting, to the network node, an indication that it is possible to configure the user equipment for single transmission reception point operation or multiple transmission reception point operation.

Example 49. A non-transitory program storage device readable by a machine, tangibly embodying a program of instructions executable by the machine for performing operations, the operations including: transmitting, to a network node, an indication to monitor a possibility of configuring a user equipment for single transmission reception point operation, or transmit, to the network node, an indication to monitor a possibility of configuring the user equipment for multiple transmission reception point operation; receiving, from the network node, an indication that it is possible to configure the user equipment for single transmission reception point operation or multiple transmission reception point operation; and configuring the user equipment for single transmission reception point operation or multiple transmission reception point operation, based on the indication received from the network node.

Example 50. A non-transitory program storage device readable by a machine, tangibly embodying a program of instructions executable by the machine for performing operations, the operations including: providing access to a first candidate cell and a second candidate cell; and performing at least one of: receiving an indication that single transmission reception point operation is configured for a user equipment, when the user equipment acquired a timing advance for the first candidate cell and failed to acquire a timing advance for the second candidate cell, or receiving an indication that multiple transmission reception point operation is configured for the user equipment without a random access channel on the first candidate cell and with a random access channel on the second candidate cell, when the user equipment acquired the timing advance for the first candidate cell and failed to acquire the timing advance for the second candidate cell; and performing the single transmission reception point operation or the multiple transmission reception point operation with the user equipment.

Example 51. A non-transitory program storage device readable by a machine, tangibly embodying a program of instructions executable by the machine for performing operations, the operations including: receiving an indication to acquire a timing advance for a first candidate cell and a timing advance for a second candidate cell; performing single transmission reception point operation with the first candidate cell, in response to acquiring the timing advance for the first candidate cell and failing to acquire the timing advance for the second candidate cell; and performing multiple transmission reception point operation without a random access channel on the first candidate cell and with a random access channel on the second candidate cell, in response to acquiring the timing advance for the first candidate cell and failing to acquire the timing advance for the second candidate cell.

References to a ‘computer’, ‘processor’, etc. should be understood to encompass not only computers having different architectures such as single/multi-processor architectures and sequential or parallel architectures but also specialized circuits such as field-programmable gate arrays (FPGAs), application specific circuits (ASICs), signal processing devices and other processing circuitry. References to computer program, instructions, code etc. should be understood to encompass software for a programmable processor or firmware such as, for example, the programmable content of a hardware device whether instructions for a processor, or configuration settings for a fixed-function device, gate array or programmable logic device etc.

The memories as described herein may be implemented using any suitable data storage technology, such as semiconductor based memory devices, flash memory, magnetic memory devices and systems, optical memory devices and systems, non-transitory memory, transitory memory, fixed memory and removable memory. The memories may comprise a database for storing data.

As used herein, the term ‘circuitry’ may refer to the following: (a) hardware circuit implementations, such as implementations in analog and/or digital circuitry, and (b) combinations of circuits and software (and/or firmware), such as (as applicable): (i) a combination of processor(s) or (ii) portions of processor(s)/software including digital signal processor(s), software, and memories that work together to cause an apparatus to perform various functions, and (c) circuits, such as a microprocessor(s) or a portion of a microprocessor(s), that require software or firmware for operation, even if the software or firmware is not physically present. As a further example, as used herein, the term ‘circuitry’ would also cover an implementation of merely a processor (or multiple processors) or a portion of a processor and its (or their) accompanying software and/or firmware. The term ‘circuitry’ would also cover, for example and if applicable to the particular element, a baseband integrated circuit or applications processor integrated circuit for a mobile phone or a similar integrated circuit in a server, a cellular network device, or another network device.

It should be understood that the foregoing description is only illustrative. Various alternatives and modifications may be devised by those skilled in the art. For example, features recited in the various dependent claims could be combined with each other in any suitable combination(s). In addition, features from different example embodiments described above could be selectively combined into a new example embodiment. Accordingly, this description is intended to embrace all such alternatives, modifications and variances which fall within the scope of the appended claims.

The following acronyms and abbreviations that may be found in the specification and/or the drawing figures are given as follows (the abbreviations and acronyms may be appended with each other or with other characters using e.g. a dash, hyphen, slash, or number, and may be case insensitive):
3GPP third generation partnership project
4G fourth generation
5G fifth generation
5GC 5G core network
AMF access and mobility management function
ASIC application-specific integrated circuit
BWP bandwidth part
CA carrier aggregation
CBRA contention based random access
CD compact/computer disc
CDM code domain multiplexing
CE control element
CFRA contention free random access
CORESET control resource set
CP cyclic prefix
CPU central processing unit
CRC cyclic redundancy check
CRI CSI-RS resource indicator
C-RNTI cell radio network temporary identifier
CSI channel state information
CSI-RS channel state information reference signal
CU central unit or centralized unit
DCI downlink control information
DL downlink
DMRS demodulation reference signal
DSP digital signal processor
DU distributed unit
DVD digital versatile disc
eNB evolved Node B (e.g., an LTE base station)
EN-DC E-UTRAN new radio-dual connectivity
en-gNB node providing NR user plane and control plane protocol terminations towards the UE, and acting as a secondary node in EN-DC
E-UTRA evolved universal terrestrial radio access, i.e., the LTE radio access technology
E-UTRAN E-UTRA network
F1 interface between the CU and the DU
FD frequency division
FDM frequency domain multiplexing
FPGA field-programmable gate array
GBBR group-based beam reporting
gNB base station for 5G/NR, i.e., a node providing NR user plane and control plane protocol terminations towards the UE, and connected via the NG interface to the 5GC
HO handover
IAB integrated access and backhaul
ID identifier
I/F interface
I/O input/output
L1 layer 1
L1/2 layer 1 and/or layer 2
L3 layer 3
LMF location management function
LTE long term evolution (4G)
LTM layer 1/2 triggered mobility
MAC medium access control
MME mobility management entity
MRO mobility robustness optimization
mTRP multiple TRP
NCE network control element
ng or NG new generation
ng-eNB new generation eNB
NG-RAN new generation radio access network
nr number
NR new radio
N/W network
OFDM orthogonal frequency division multiplexing
PBCH physical broadcast channel
PCI physical layer cell ID
PDA personal digital assistant
PDCCH physical downlink control channel
PDCP packet data convergence protocol
PDSCH physical downlink shared channel
PHY physical layer
PRACH physical random access channel
PUCCH physical uplink control channel
PUSCH physical uplink shared channel
R release
RA random access
RACH random access channel
RAM random access memory
RAN radio access network
RAN2 radio layer 2
RAR random access response
RB resource block
RE resource element
Rel release
RLC radio link control
RO RACH occasion
ROM read-only memory
RRC radio resource control
RS reference signal
RSRP reference signal received power
RU radio unit
Rx receiver or reception
SDAP service data adaptation protocol
SDM spatial domain multiplexing
SGW serving gateway
SMF session management function
SON self-organizing/optimizing network
SRS sounding reference signal
SS synchronization signal
SSB synchronization signal and PBCH block, or synchronization signal block
SSBRI SS/PBCH block resource indicator
STRP single TRP
SUL supplementary uplink
TA timing advance
TAG timing advance group
TCI transmission configuration indication
TD time division
TDM time domain multiplexing
TRP transmission reception point
TS technical specification
Tx, TX transmitter or transmission
UAV unmanned aerial vehicle
UE user equipment (e.g., a wireless, typically mobile device)
UI user interface
UL uplink
UPF user plane function
USB universal serial bus
X2 network interface between RAN nodes and between RAN and the core network
Xn network interface between NG-RAN nodes

1.-51. (canceled)

52. An apparatus comprising:
at least one processor; and
at least one memory storing instructions that, when executed by the at least one processor, cause the apparatus at least to:
receive, from a network node, an indication to monitor a possibility of configuring a user equipment for single transmission reception point operation, or receive, from the network node, an indication to monitor a possibility of configuring the user equipment for multiple transmission reception point operation;
determine whether it is possible to configure the user equipment for single transmission reception point operation or multiple transmission reception point operation; and
transmit, to the network node, an indication that it is possible to configure the user equipment for single transmission reception point operation or multiple transmission reception point operation.

53. The apparatus of claim 52, wherein the instructions, when executed by the at least one processor, cause the apparatus at least to:
configure the user equipment to acquire a timing advance for a first candidate cell and a timing advance for a second candidate cell;
determine that the user equipment acquired the timing advance for the first candidate call and failed to acquire the timing advance for the second candidate cell; and
perform at least one of:
indicate, to the network node, single transmission reception point operation with the first candidate cell for the user equipment, or
determine to configure the user equipment for multiple transmission reception point operation with a random access channel with the second candidate cell and without a random access channel with the first candidate cell.

54. The apparatus of claim 53, wherein the instructions, when executed by the at least one processor, cause the apparatus at least to:
transmit, to the user equipment, a cell switch indication to: perform a cell switch with multiple transmission reception point operation while retrying to acquire the timing advance for the second candidate cell.

55. The apparatus of claim 54, wherein the cell switch indication transmitted to the user equipment to perform the cell switch with multiple transmission reception point operation while retrying to acquire the timing advance for the second candidate cell comprises an explicit indication or an implicit indication.

56. The apparatus of claim 55, wherein the cell switch indication comprises the implicit indication when a beam indication associated with the second candidate cell does not comprise a valid timing advance value, wherein the beam indication associated with the second candidate cell is within the cell switch indication, and wherein a beam indication associated with the first candidate cell comprises a valid timing advance value, wherein the beam indication associated with the first candidate cell is within the cell switch indication.

57. The apparatus of claim 52, wherein the instructions, when executed by the at least one processor, cause the apparatus at least to:
transmit an indication that single transmission reception point operation is configured for the user equipment, or
transmit an indication that multiple transmission reception point operation is configured for the user equipment without a random access channel on a first candidate cell and with a random access channel on a second candidate cell.

58. The apparatus of claim 57, wherein the indication that single transmission reception point operation is configured for the user equipment, and the indication that multiple transmission reception point operation is configured for the user equipment without a random access channel on the first candidate cell and with a random access channel on the second candidate cell, are transmitted to the network node or to a distributed unit associated with the first candidate cell and the second candidate cell.

59. The apparatus of claim 57, wherein the instructions, when executed by the at least one processor, cause the apparatus at least to:
receive a configuration to transmit the indication that single transmission reception point operation is configured for the user equipment, and to transmit the indication that multiple transmission reception point operation is configured for the user equipment without a random access channel on a first candidate cell and with a random access channel on a second candidate cell.

60. The apparatus of claim 52, wherein the instructions, when executed by the at least one processor, cause the apparatus at least to:
receive, from the user equipment, an indication of successful timing advance acquisition; and
determine that multiple transmission reception operation is possible for the user equipment, based on the indication of successful timing advance acquisition; and
indicate, to the network node, that multiple transmission reception operation is possible for the user equipment.

61. The apparatus of claim 52, wherein the instructions, when executed by the at least one processor, cause the apparatus at least to:
receive, from the network node, a configuration for measurement reporting related to multiple transmission reception point operation;
receive at least one measurement from the user equipment; and
determine whether it is possible to configure the user equipment for multiple transmission reception point operation, based on the at least one measurement and the configuration for measurement reporting.

62. The apparatus of claim 61, wherein the configuration for measurement reporting comprises a mapping between reference signals and target transmission reception points of a distributed unit.

63. The apparatus of claim 62, wherein the instructions, when executed by the at least one processor, cause the apparatus at least to:
receive, from the user equipment based on the at least one measurement, an indication of reception of multiple beams from multiple transmission reception points;
determine that it is possible to configure the user equipment for multiple transmission reception point operation, based on the indication of reception of multiple beams from multiple transmission reception points received from the user equipment.

64. The apparatus of claim 52, wherein the instructions, when executed by the at least one processor, cause the apparatus at least to:
determine that multiple timing advances are available at the user equipment; and
determine that it is possible to configure the user equipment for multiple transmission reception point operation due to the multiple timing advances being available at the user equipment.

65. An apparatus comprising:
at least one processor; and
at least one memory storing instructions that, when executed by the at least one processor, cause the apparatus at least to:
transmit, to a network node, an indication to monitor a possibility of configuring a user equipment for single transmission reception point operation, or transmit, to the network node, an indication to monitor a possibility of configuring the user equipment for multiple transmission reception point operation;
receive, from the network node, an indication that it is possible to configure the user equipment for single transmission reception point operation or multiple transmission reception point operation; and
configure the user equipment for single transmission reception point operation or multiple transmission reception point operation, based on the indication received from the network node.

66. The apparatus of claim 65, wherein the instructions, when executed by the at least one processor, cause the apparatus to at least one of:
transmit, to the network node, an indication to monitor whether the user equipment acquired a timing advance for a first candidate call and for a second candidate cell; or
receive, from the network node, an indication of single transmission reception point operation with a first candidate cell for the user equipment, when the user equipment acquired a timing advance for the first candidate cell and failed to acquire a timing advance for a second candidate cell, or
receive, from the network node, an indication of multiple transmission reception point operation for the user equipment with the first candidate cell and the second candidate cell, when the user equipment acquired a timing advance for the first candidate cell and failed to acquire the timing advance for the second candidate cell;
transmit, to the network node, a configuration to transmit an indication that single transmission reception point operation is configured for the user equipment, and to transmit an indication that multiple transmission reception point operation is configured for the user equipment without a random access channel on a first candidate cell and with a random access channel on a second candidate cell.

67. The apparatus of claim 65, wherein the indication of multiple transmission reception point operation for the user equipment indicates that multiple transmission reception point operation is configured for the user equipment without a random access channel on the first candidate cell and with a random access channel on the second candidate cell.

68. The apparatus of claim 65, wherein the instructions, when executed by the at least one processor, cause the apparatus at least to:
receive, from the network node, an indication that multiple transmission reception operation is possible for the user equipment; and
configure the user equipment for multiple transmission reception point operation, based on the received indication that multiple transmission reception operation is possible for the user equipment.

69. The apparatus of claim 65, wherein the instructions, when executed by the at least one processor, cause the apparatus at least to:
transmit, to the network node, a configuration for measurement reporting related to multiple transmission reception point operation, wherein the configuration for measurement reporting is configured to be used for a determination of whether multiple transmission reception point operation is possible for the user equipment.

70. An apparatus comprising:
at least one processor; and
at least one memory storing instructions that, when executed by the at least one processor, cause the apparatus at least to:
provide access to a first candidate cell and a second candidate cell; and
perform at least one of:
receive an indication that single transmission reception point operation is configured for a user equipment, when the user equipment acquired a timing advance for the first candidate cell and failed to acquire a timing advance for the second candidate cell, or
receive an indication that multiple transmission reception point operation is configured for the user equipment without a random access channel on the first candidate cell and with a random access channel on the second candidate cell, when the user equipment acquired the timing advance for the first candidate cell and failed to acquire the timing advance for the second candidate cell; and
perform the single transmission reception point operation or the multiple transmission reception point operation with the user equipment.

71. The apparatus of claim 70, wherein the instructions, when executed by the at least one processor, cause the apparatus to at least one of:
release at least one resource associated with the second candidate cell; or
transmit, to a distributed unit associated with a source cell, a configuration to perform at least one of:
a transmission of the indication that single transmission reception point operation is configured for the user equipment, or
a transmission of the indication that multiple transmission reception point operation is configured for the user equipment without the random access channel on the first candidate cell and with the random access channel on the second candidate cell.
